(19) United States
(12) Patent Application Publication
(10) Pub. No.: US 2015/0344013 A1
(43) Pub. Date: Dec. 3, 2015

(54) Electrohydraulic Motor Vehicle Brake System and Method for Operating the Same

(71) Applicant: Lucas Automotive GmbH, Koblenz (DE)

(72) Inventors: Josef Knechtges, Mayen (DE); Thomas Wagner, Vallendar (DE)

(73) Assignee: Lucas Automotive GmbH, Koblenz (DE)

(21) Appl. No.: 14/654,645

(22) PCT Filed: Nov. 28, 2013
(86) PCT No.: PCT/EP2013/074927

§ 371 Date: Jun. 22, 2015

(30) Foreign Application Priority Data
Dec. 21, 2012 (DE) 10 2012 025 249.8

(51) Int. Cl. B60T 13/58; B60T 13/74; B60T 13/66; B60T 8/17

(52) U.S. Cl. CPC B60T 13/588; B60T 8/17; B60T 13/745; B60T 13/662

(57) ABSTRACT

The invention relates to an electrohydraulic motor vehicle brake system. The brake system comprises a master cylinder, an electromechanical actuator for actuating a piston, which is accommodated in the master cylinder, in a brake-by-wire (BBW) mode of the brake system, and a mechanical actuator, which can be actuated by means of a brake pedal, for actuating the piston in a push-through (PT) mode of the brake system. In the BBW mode, a gap having a defined gap length is present in a force transmission path between the brake pedal and the piston for decoupling the brake pedal from the piston. The brake system is configured such that in the BBW mode the gap length is dependent on a pedal travel of the brake pedal.

### CROSS-REFERENCE TO RELATED APPLICATIONS

This application is a national stage of International Application No. PCT/EP2013/074927 filed Nov. 28, 2013, and which claims priority to German to Patent Application No. 10 2012 025 249.8 filed Dec. 21, 2012, the disclosures of which are incorporated herein by reference in their entirety.

### BACKGROUND OF THE INVENTION

The present disclosure relates generally to the field of vehicle brake systems.

In concrete terms, an electrohydraulic vehicle brake system will be described having an electromechanical actuator for actuating the brake system.

Electromechanical actuators have found application for some time in vehicle brake systems, for example for the purpose of realising an electrical park-brake function (EPB). In electromechanical brake systems (EMB) they replace the conventional hydraulic cylinders at the wheel brakes.

By reason of technical progress, the performance of electromechanical actuators has been continually enhanced. Consideration has therefore been given to making use of actuators of such a type also for the purpose of implementing modern systems for vehicle dynamics control. Counted among such control systems are an anti-lock braking system (ABS), an anti-slip regulation system (ASR) and an electronic stability program (ESP), also designated as vehicle stability control (VSC).

WO 2006/111393 A teaches an electrohydraulic brake system with a highly dynamic electromechanical actuator which undertakes the pressure modulation in the vehicle-dynamics control mode. The electromechanical actuator described in WO 2006/111393 A has been provided to act directly on a master cylinder of the brake system. By reason of the high dynamics of the electromechanical actuator, the hydraulic components of the brake system known from WO 2006/111393 A can be reduced to a single 2/2-way valve per wheel brake. For the purpose of realising wheel-specific pressure modulations, the valves are then driven individually or in groups in the multiplex mode.

However, challenges also result from the minimisation to merely one valve per wheel brake, such as an unwanted equalisation of pressure when the valves are open simultaneously. A solution for this, based on a highly dynamic control behaviour, is specified in WO 2010/091883 A.

WO 2010/091883 A discloses an electrohydraulic brake system with a master cylinder and with a tandem piston received therein. The tandem piston is capable of being actuated by means of an electromechanical actuator. The electromechanical actuator comprises an electric motor arranged concentrically with respect to the tandem piston and also a gearing arrangement which converts a rotational motion of the electric motor into a translational motion of the piston. The gearing arrangement consists of a ball-screw drive, with a ball-screw nut coupled in torsion-resistant manner with a rotor of the electric motor, and a ball-screw spindle acting on the tandem piston.

Another electrohydraulic brake system with an electromechanical actuator acting on a master cylinder is known from WO 2012/152352 A. This system can operate in a regenerative mode (generator operation).

### SUMMARY OF THE INVENTION

An electrohydraulic motor-vehicle brake system and also a method for operating such a brake system are to be specified which exhibit a functionality that is advantageous, particularly from the point of view of safety.

According to one aspect, an electrohydraulic motor-vehicle brake system is specified that comprises a master cylinder, an electromechanical actuator for actuating a first piston received in the master cylinder in a brake-by-wire (BBW) mode of the brake system, and a mechanical actuator, capable of being actuated by means of a brake pedal, for actuating the first piston in a push-through (PT) mode of the brake system. In the BBW mode, a gap is present having a gap length in a force-transmitting path between the brake pedal and the first piston, in order to decouple the brake pedal from the first piston. The brake system is configured in such a manner that in the BBW mode the gap length exhibits a dependence on a pedal travel of the brake pedal.

The piston received in the master cylinder can be actuated directly or indirectly by the electromechanical actuator. For example, the electromechanical actuator may have been arranged with a view to direct action on the piston of the master cylinder. For this purpose said actuator may have been mechanically coupled with the piston or may be capable of being mechanically therewith. The piston can then be actuated directly by the actuator. Alternatively to this, the electromechanical actuator can interact with a cylinder/piston device of the brake system that is different from the master cylinder. Furthermore, the cylinder/piston device may have been fluidically coupled on the outlet side with the piston of the master cylinder. In this case, the piston of the master cylinder can be actuated hydraulically via a hydraulic pressure provided by the cylinder/piston device (and with the aid of the electromechanical actuator).

The dependence of the gap length on the pedal travel may have been designed differently, depending on the given requirements. According to one implementation, the gap length increases with a depression of the brake pedal. This increase may occur continuously or discontinuously (e.g. in stages). Furthermore, the increase may occur proportionally (for example, linearly) or non-proportionally relative to the pedal travel. Additionally or alternatively to this, the gap length may decrease with an easing back on the brake pedal. The dependence of the gap length on the pedal travel may be identical or variable when depressing and easing back on the brake pedal. In the case of variable dependences it is possible for a hysteresis, for example, to be configured.

Generally, the dependence of the gap length on the pedal travel may have been defined by a transmission ratio. The transmission ratio may be established, for example, between a distance travelled by a pedal-side boundary of the gap and a distance travelled by a piston-side boundary of the gap. The transmission ratio may expediently lie within the range between about 1:1.25 and 1:5 (for example, between about 1:1.5 and 1:4).

The length of the gap in an unactuated position of the brake pedal may amount to between about 0.5 mm and 2 mm (for example, about 1 mm). Generally, the gap may have been bounded between a first end face of the first piston or a first actuating element capable of being moved with the first piston, on one side, and a second end face of a second actuating element coupled with the brake pedal, on the other side. In the PT mode, the first end face and the second end face may be capable of being brought into abutment, overcoming the gap. In this way, the first piston can be actuated mechanically by means of the brake pedal.

The dependence of the gap length on the pedal travel may have been realised by a pedal-travel-dependent and/or a pedal-force-dependent drive capability of the electromechanical actuator. For this purpose a pedal-travel sensor and/or a pedal-force sensor may have been built in. The corresponding output signals can be evaluated by a control unit driving the electromechanical actuator.

According to a variant, the electromechanical actuator can be driven in such a manner that in the event of a depression of the brake pedal the first piston is traversed more quickly by means of the electromechanical actuator than a pedal-side boundary of the gap lagging behind the first piston. In this way, it is possible for a gap length increasing with the depression of the brake pedal to be realised.

The electromechanical actuator may be capable of being driven, in order to bring about, in the case of an at least partially depressed brake pedal, a return stroke of the first cylinder in the direction towards the brake pedal. A return stroke of such a type may happen for differing purposes, for example for the purpose of sucking hydraulic fluid out of a reservoir into the master cylinder. According to one implementation, such a return stroke is carried out in a vehicle-dynamics control mode if it is detected that the volume of hydraulic fluid still available in the master cylinder is no longer sufficient. The return stroke of the first cylinder may be accompanied by a hydraulic uncoupling of wheel brakes from the master cylinder. Furthermore, for this purpose a valve between the master cylinder and the reservoir may be opened.

In one implementation of the brake system, in addition to the master cylinder a further hydraulic cylinder with a second piston received therein has been provided. The brake pedal may have been coupled with the second piston in order to displace hydraulic fluid out of the hydraulic cylinder in the event of a depression of the brake pedal. The second piston in this case may have been rigidly coupled with an actuating element forming a pedal-side boundary of the gap. This actuating element may have a generally rod-like shape.

The brake system may include, moreover, a hydraulic simulation device for a pedal-reaction response. This simulation device may have been designed to accommodate hydraulic fluid displaced out of the hydraulic cylinder by actuation of the second piston.

A stop valve may have been provided between the master cylinder and the simulation device. For the purpose of limiting the pedal travel, the hydraulic cylinder may have been designed to be separable from the simulation device by means of the stop valve. A pedal-travel limitation may have been provided for differing purposes. For instance, the pedal-travel limitation may be activated in a vehicle-dynamics control mode. In this way, it is possible for a haptic feedback to be output to the driver by virtue of a shortening of the pedal travel (in comparison with a normal braking). The haptic feedback may in this case indicate the starting or ending of the vehicle-dynamics control. According to a variant, the pedal travel is limited in the vehicle-dynamic control mode as a function of a coefficient of static friction of a roadway surface. In this case the pedal travel may turn out to be shorter (that is to say, the pedal-travel limitation may start more quickly), the lower the coefficient of static friction.

According to a further aspect, a method is specified for operating a electrohydraulic motor-vehicle brake system that comprises a master cylinder, an electromechanical actuator for actuating a first piston received in the master cylinder in a BBW mode of the brake system, and a mechanical actuator, capable of being actuated by means of a brake pedal, for actuating the first piston in a PT mode of the brake system, wherein in the BBW mode a gap having a gap length is present in a force-transmitting path between the brake pedal and the first piston, in order to decouple the brake pedal from the first piston. The method comprises the step of setting, in the BBW mode, the gap length as a function of a pedal travel of the brake pedal.

Likewise provided is a computer-program product with program-code means for implementing the method presented herein when the computer-program product is running on at least one processor. The computer-program product may have been encompassed by a motor-vehicle control unit or motor-vehicle control-unit system.

Depending on the configuration of the vehicle brake system, the decoupling of the brake pedal from the master-cylinder piston by means of the gap may happen for differing purposes. In the case of a brake system generally designed in accordance with the BBW principle, apart from an emergency-braking operation in which the PT mode has been activated a permanent decoupling may have been provided. In the case of a regenerative brake system, a decoupling of such a type can be effected at least within the scope of a regenerative braking operation (generator operation) in respect of at least one vehicle axle.

For the purpose of driving the electromechanical actuator and also optional further components of the vehicle brake system, the brake system may exhibit suitable drive devices. These drive devices may include electrical, electronic or program-controlled assemblies and also combinations thereof. For example, the drive devices may be provided in a common control unit or in a system consisting of separate electronic control units (ECUs).

Other advantages of this invention will become apparent to those skilled in the art from the following detailed description of the preferred embodiments, when read in light of the accompanying drawings.

### BRIEF DESCRIPTION OF THE DRAWINGS

FIG. 1 a first embodiment of an electrohydraulic vehicle brake system;

FIG. 2 a second embodiment of an electrohydraulic vehicle brake system;

FIG. 3 a third embodiment of an electrohydraulic vehicle brake system;

FIG. 4 a fourth embodiment of an electrohydraulic vehicle brake system;

FIG. 5A a schematic view of the unactuated normal position of the brake system according to one of FIGS. 1 to 4;

FIG. 5B a schematic view of the actuation position of the brake system 6A and 6B schematic diagrams that illustrate in exemplary manner the dependence of a gap length on a brake-pedal travel.

### DETAILED DESCRIPTION OF THE PREFERRED EMBODIMENTS

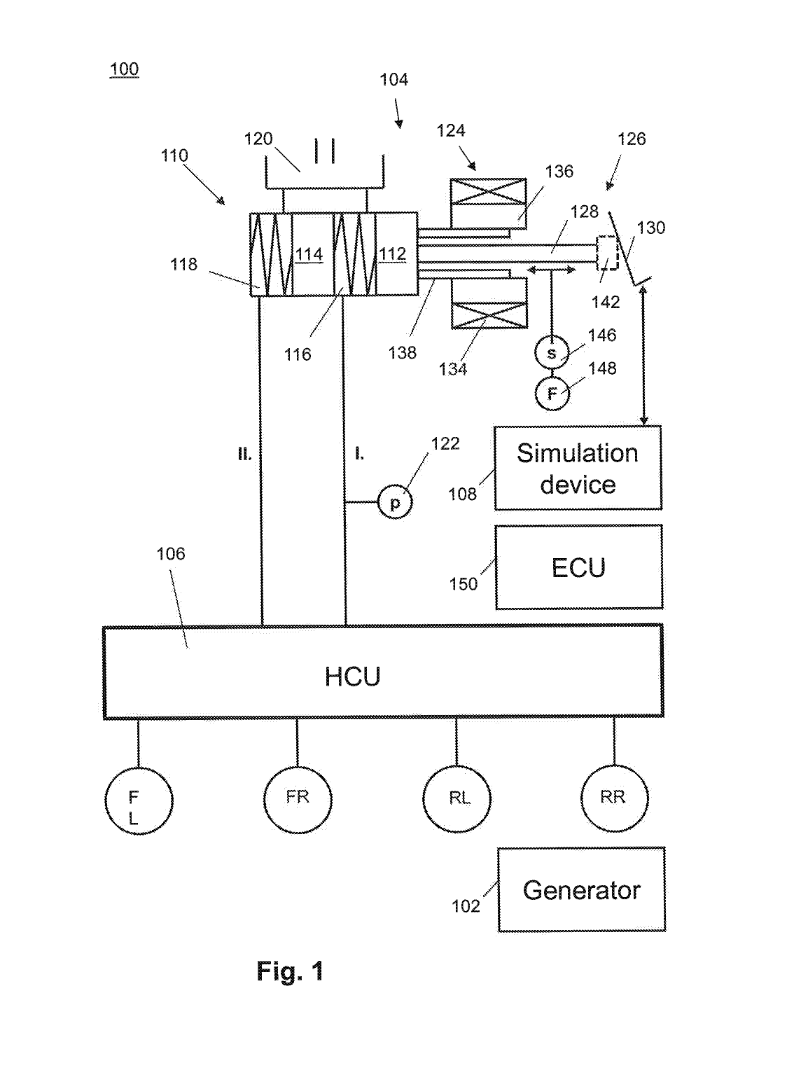

FIG. 1 shows a first embodiment of a hydraulic vehicle brake system 100 which is based on the brake-by-wire (BBW) principle. The brake system 100 can optionally be operated (e.g. in hybrid vehicles) in a regenerative mode. For this purpose an electrical machine 102 has been provided which offers a generator functionality and can be selectively connected to wheels and to an energy storage device, for example a battery (not represented).

As illustrated in FIG. 1, the brake system 100 includes a master-cylinder assembly 104 which can be mounted on a vehicle bulkhead. A hydraulic control unit (HCU) 106 of the brake system 100 has been functionally arranged between the master-cylinder assembly 104 and four wheel brakes FL, FR, RL and RR of the vehicle. The HCU 106 takes the form of an integrated assembly and comprises a plurality of hydraulic individual components and also several fluid inlets and fluid outlets. Furthermore, a simulation device 108, represented only schematically, has been provided for making available a pedal-reaction response in the service-braking mode. The simulation device 108 may be based on a mechanical or hydraulic principle. In the last-mentioned case the simulation device 108 may have been connected up to the HCU 106.

The master-cylinder assembly 104 exhibits a master cylinder 110 with a piston relocatably received therein. In the embodiment the piston takes the form of a tandem piston with a primary piston 112 and with a secondary piston 114 and defines in the master cylinder 110 two hydraulic chambers 116, 118 separated from one another. With a view to supply with hydraulic fluid via a respective port, the two hydraulic chambers 116, 118 of the master cylinder 110 have been connected to a pressureless hydraulic-fluid reservoir 120. Each of the two hydraulic chambers 116, 118 has furthermore been coupled with the HCU 106 and defines a brake circuit I. and II., respectively. In the embodiment a hydraulic-pressure sensor 122 for brake circuit I. has been provided, which could also be integrated into the HCU 106.

The master-cylinder assembly 104 further includes an electromechanical actuator (i.e. an electromechanical adjusting element) 124 as well as a mechanical actuator (i.e. a mechanical adjusting element) 126. Both the electromechanical actuator 124 and the mechanical actuator 126 enable an actuation of the master-cylinder piston and for this purpose act on an input-side end face of this piston, more precisely of the primary piston 112. The actuators 124, 126 have been designed in such a manner that they are able to actuate the master-cylinder piston independently of one another (and separately or jointly).

The mechanical actuator 126 possesses a force-transmitting element 128 which is rod-shaped and is able to act directly on the input-side end face of the primary piston 112. As shown in FIG. 1, the force-transmitting element 128 has been coupled with a brake pedal 130. It will be understood that the mechanical actuator 126 may include further components which have been functionally arranged between the brake pedal 130 and the master cylinder 110. Further components of such a type may be both of mechanical nature and of hydraulic nature. In the last-mentioned case the actuator 126 takes the form of a hydraulic/mechanical actuator 126.

The electromechanical actuator 124 exhibits an electric motor 134 and also a gear mechanism 136, 138 following the electric motor 134 on the output side. In the embodiment the gear mechanism is an arrangement consisting of a rotatably supported nut 136 and a spindle 138 in engagement with the nut 136 (e.g. via rolling elements such as balls) and mobile in the axial direction. In other embodiments, rack-and-pinion gear mechanisms or other types of gear mechanism may find application.

In the present embodiment the electric motor 134 possesses a cylindrical structural shape and extends concentrically in relation to the force-transmitting element 128 of the mechanical actuator 126. More precisely, the electric motor 134 has been arranged radially on the outside with respect to the force-transmitting element 128. A rotor (not represented) of the electric motor 134 has been coupled in torsion-resistant manner with the gearing nut 136, in order to set the latter in rotation. A rotary motion of the nut 136 is transmitted to the spindle 138 in such a manner that an axial relocation of the spindle 138 results. The end face of the spindle 138 on the left in FIG. 1 may in this case (where appropriate, via an intermediate member) come into abutment against the end face of the primary piston 112 on the right in FIG. 1 and may in consequence of this relocate the primary piston 112 (together with the secondary piston 114) to the left in FIG. 1. Furthermore, it is also possible for the piston arrangement 112, 114 to be relocated to the left in FIG. 1 by the force-transmitting element 128 of the mechanical actuator 126 extending through the spindle 138 (taking the form of a hollow body). A relocation of the piston arrangement 112, 114 to the right in FIG. 1 is brought about by means of the hydraulic pressure prevailing in the hydraulic chambers 116, 118 (upon release of the brake pedal 130 and, where appropriate, in the case of motorised relocation of the spindle 138 to the right).

In the variant of the master-cylinder assembly 104 shown in FIG. 1, the electromechanical actuator 124 has been arranged in such a manner that it can act directly on the piston (more precisely, on the primary piston 112) of the master cylinder 110 for the purpose of building up a hydraulic pressure at the wheel brakes. In other words, piston 112 of the master cylinder 110 is mechanically actuated directly by the electromechanical actuator 124. In an alternative configuration of the master-cylinder assembly 104, the piston of the master cylinder 110 can be actuated hydraulically (not represented in FIG. 1) with the aid of the electromechanical actuator 124. In this case the master cylinder 110 may have been fluidically coupled with a further cylinder/piston device interacting with the electromechanical actuator 124. In concrete terms, the cylinder/piston device coupled with the electromechanical actuator 124 may have been fluidically coupled on the outlet side with the primary piston 112 of the master cylinder 110, for example in such a manner that a hydraulic pressure generated in the cylinder/piston device acts directly on the primary piston 112 and consequently results in an actuation of the primary piston 112 in the master cylinder 110. In one realisation the primary piston 112 is then relocated so far by reason of the hydraulic pressure acting in the master cylinder 110 (relocation to the left in FIG. 1) until the hydraulic pressure generated in the master-cylinder chambers 116, 118 corresponds to the hydraulic pressure generated in the additional cylinder/piston device.

As shown in FIG. 1, a decoupling device 142 has been functionally provided between the brake pedal 130 and the force-transmitting element 128. The decoupling device 142 enables a selective decoupling of the brake pedal 130 from the piston arrangement 112, 114 in the master cylinder 110. In the following, the modes of operation of the decoupling device 142 and of the simulation device 108 will be elucidated in more detail. In this context it should be pointed out that the brake system 100 represented in FIG. 1 is based on the brake-by-wire (BBW) principle. This means that within the scope of a normal service braking both the decoupling device 142 and the simulation device 108 have been activated. Accordingly, the brake pedal 130 has been decoupled from the force-transmitting element 128 (and hence from the piston arrangement 112, 114 in the master cylinder 110) via a gap which is not represented in FIG. 1, and an actuation of the piston arrangement 112, 114 can be effected exclusively via the electromechanical actuator 124. The habitual pedal-reaction response is provided in this case by the simulation device 108 coupled with the brake pedal 130.

Within the scope of the service braking the electromechanical actuator 124 therefore undertakes the function of braking-force generation. A braking force demanded as a result of depression of the brake pedal 130 is generated in this case by virtue of the fact that by means of the electric motor 134 the spindle 138 is relocated to the left in FIG. 1 and thereby also the primary piston 112 and the secondary piston 114 of the master cylinder 110 are moved to the left. In this way, hydraulic fluid is conveyed out of the hydraulic chambers 116, 118 to the wheel brakes FL, FR, RL and RR via the HCU 106.

The level of the braking force, resulting from this, of the wheel brakes FL, FR, RL and RR is set as a function of an actuation of the brake pedal registered by sensor means. For this purpose, a distance sensor 146 and a force sensor 148 have been provided, the output signals of which are evaluated by an electronic control unit (ECU) 150 driving the electric motor 134. The distance sensor 146 registers an actuation distance associated with an actuation of the brake pedal 130, whereas the force sensor 148 registers an associated actuation force. As a function of the output signals of the sensors 146, 148 (and also, where appropriate, of the pressure sensor 122) a drive signal for the electric motor 134 is generated by the control unit 150.

In the present embodiment the drive of the electric motor 134 (and hence of the electromechanical actuator 124) is effected in such a manner that the length of the aforementioned gap for decoupling the brake pedal 130 from the master-cylinder/piston arrangement 112, 114 exhibits a dependence on the pedal travel of the brake pedal 130. The dependence has been chosen in such a manner that the gap length increases with a depression of the brake pedal 130 (that is to say, with increasing pedal travel). For this purpose the control unit 150 evaluates the output signal of the distance sensor 146 (and, additionally or alternatively, of the force sensor 148) and drives the electromechanical actuator 124 in such a manner that in the event of a depression of the brake pedal 130 the piston arrangement 112, 114 is traversed to the left in FIG. 1 more quickly than a brake-pedal-side boundary of the gap lagging behind the piston arrangement 112, 114.

Now that the processes in the case of a service braking (BBW mode) have been elucidated in more detail, the PT mode will now be briefly described in the case of an emergency-braking mode. The emergency-braking mode is, for example, the consequence of the failure of the vehicle battery or of a component of the electromechanical actuator 124. A deactivation of the decoupling device 142 (and of the simulation device 108) in the emergency-braking mode enables a direct coupling of the brake pedal 130 with the master cylinder 110, namely via the force-transmitting element 128.

The emergency braking is initiated by depressing the brake pedal 130. The actuation of the brake pedal is then transmitted, overcoming the aforementioned gap, to the master cylinder 110 via the force-transmitting element 128. As a consequence of this, the piston arrangement 112, 114 is relocated to the left in FIG. 1. As a result, hydraulic fluid is conveyed out of the hydraulic chambers 116, 118 of the master cylinder 110 to the wheel brakes FL, FR, RL and RR via the HCU 106 for the purpose of generating braking force.

According to a first embodiment, the HCU 106 possesses a structure that is conventional in principle with respect to the vehicle-dynamics control mode (brake-control functions such as ABS, ASR, ESP, etc.), with a total of 12 valves (in addition to valves that are used, for example, in connection with the activation and deactivation of the decoupling device 142 and of the simulation device 108). Since the electromechanical actuator 124 is then driven (where appropriate, exclusively) within the scope of a generation of braking force, the additional control functions are brought about in known manner by means of the HCU 106 (and, where appropriate, a separate hydraulic-pressure generator such as a hydraulic pump). But a hydraulic-pressure generator in the HCU 106 may also be dispensed with. The electromechanical actuator 124 then additionally undertakes the pressure modulation within the scope of the control mode. A corresponding control mechanism is implemented for this purpose in the control unit 150 provided for the electromechanical actuator 124.

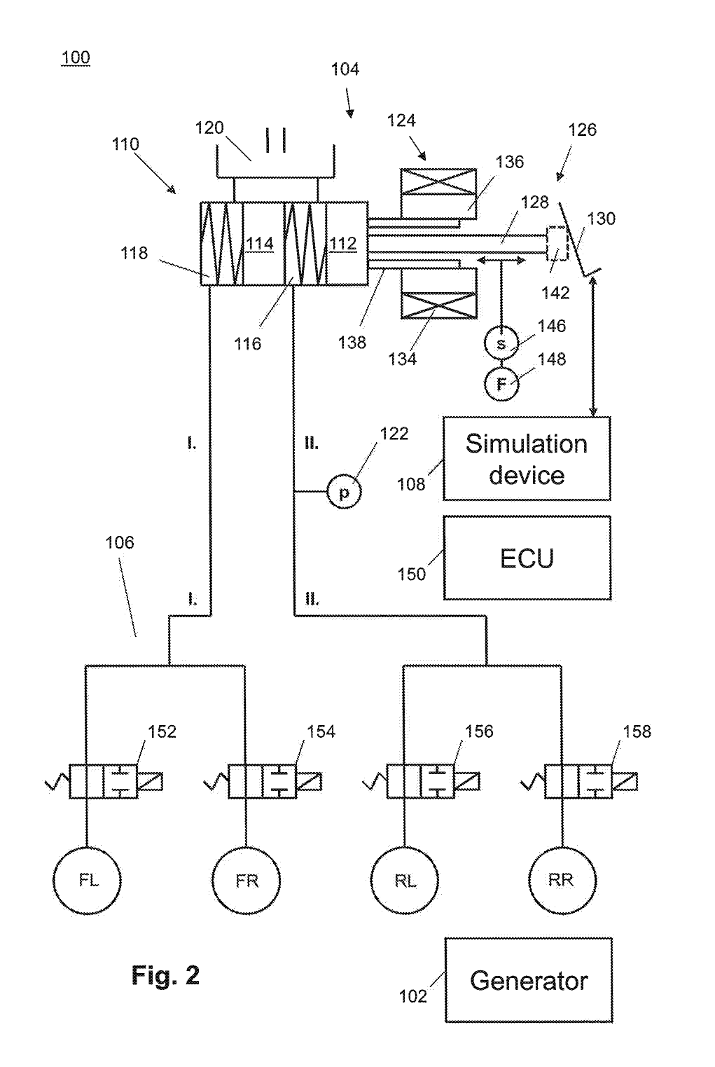

In a further version according to FIG. 2, in the HCU 106 the special valves for the vehicle-dynamics control mode (e.g. the ASR mode and ESP mode) may be omitted, with the exception of four valves 152, 154, 156, 158. So in this other version of the HCU 106 the valve arrangement known from WO 2010/091883 A or WO 2011/141158 A (cf. FIG. 15) with merely four valves 152, 154, 156, 158 (and with the corresponding drive) may be fallen back upon. The hydraulic-pressure modulation in the control mode is then also effected by means of the electromechanical actuator 124. In other words, the electromechanical actuator 124 in this case is driven not only with a view to the generation of braking force within the scope of a service braking, but also, for example, for the purpose of vehicle-dynamics control (that is to say, for example, in the ABS and/or ASR and/or ESP control mode). Together with the drive of the electromechanical actuator 124, a wheel-specific or wheel-group-specific drive of the valves 152, 154, 156, 158 is effected in the multiplex mode. In the implementation shown in FIG. 2 no further valves for purposes of vehicle-dynamics control are present between the valves 152, 154, 156, 158 and the master cylinder.

The multiplex mode may be a time-division multiplex mode. In this case, individual time slots may generally be predetermined. To an individual time slot, in turn, one or more of the valves 152, 154, 156, 158 may have been assigned which are actuated during the corresponding time slot (for example, by single or repeated change(s) of the switching status from open to closed and/or conversely). According to one realisation, precisely one time slot has been assigned to each of the valves 152, 154, 156, 158. One or more further time slots may be assigned to one or more further valve arrangements (not represented in FIG. 2).

In the multiplex mode, firstly several or all of the valves 152, 154, 156, 158 may, for example, be open, and at the same time by means of the electromechanical actuator 124 a hydraulic pressure may be built up at several or all of the assigned wheel brakes FL, FR, RL and RR. Upon attaining a wheel-specific target pressure, the corresponding valve 152, 154, 156, 158 then closes, in time-slot-synchronous manner, whereas one or more further valves 152, 154, 156, 158 continue to remain open until such time as the respective target pressure has been attained there too. The four valves 152, 154, 156, 158 are therefore opened and closed in the multiplex mode individually for each wheel or wheel group as a function of the respective target pressure.

According to one implementation, the valves 152, 154, 156, 158 have been realised as 2/2-way valves and take the form, for example, of non-controllable stop valves. In this case, therefore, no aperture cross-section can be set such as would be the case, for example, with proportional valves. In another implementation, the valves 152, 154, 156, 158 have been realised as proportional valves with adjustable aperture cross-section.

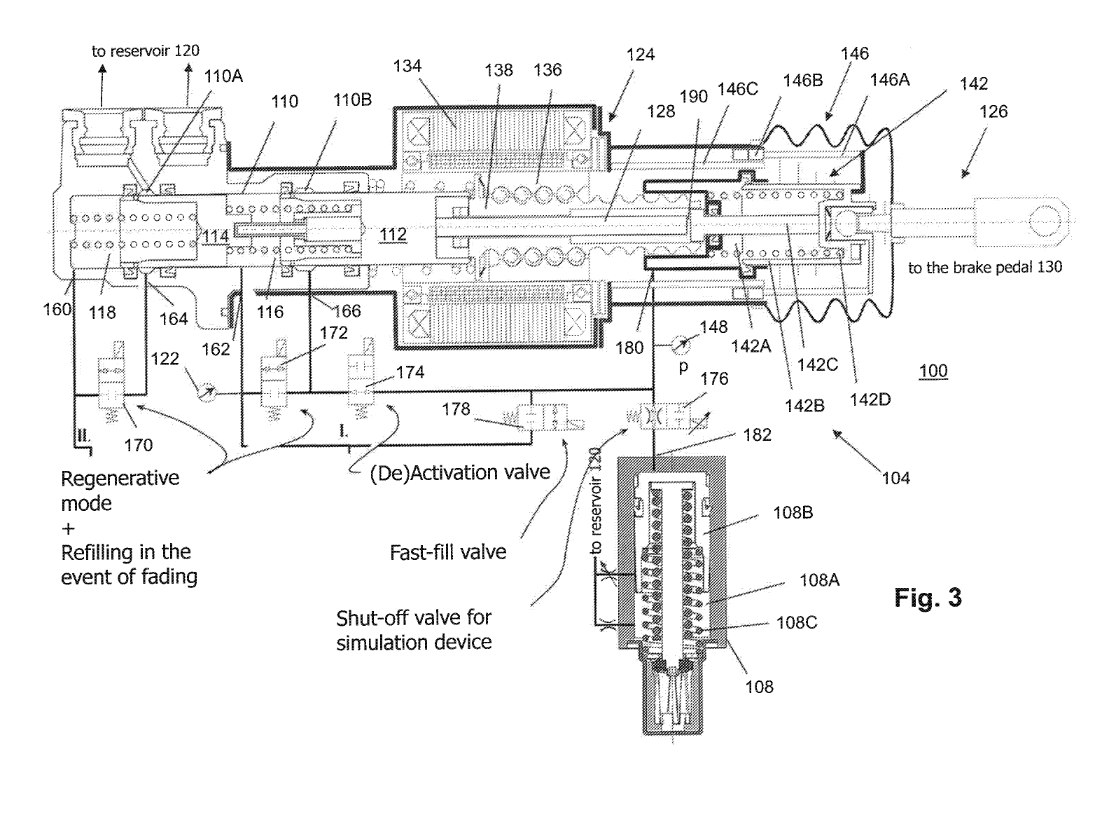

FIG. 3 shows a more detailed embodiment of a vehicle brake system 100 which is based on the functional principle elucidated in connection with the schematic embodiments shown in FIGS. 1 and 2. Identical or similar elements have been provided in this case with the same reference symbols as in FIGS. 1 and 2, and the elucidation thereof will be dispensed with in the following. For the sake of clarity, the ECU, the wheel brakes, the valve units of the HCU assigned to the wheel brakes, and the generator for the regenerative braking mode have not been represented.

The vehicle brake system 100 illustrated in FIG. 3 also includes two brake circuits I. and II., whereby two hydraulic chambers 116, 118 of a master cylinder 110 have been assigned respectively, in turn, to precisely one brake circuit L, II. The master cylinder 110 possesses two ports per brake circuit I., II.. The two hydraulic chambers 116, 118 in this case discharge respectively into a first port 160, 162, via which hydraulic fluid can be conveyed out of the respective chamber 116, 118 into the assigned brake circuit I., II. Furthermore, each of the brake circuits I. and II. can be connected, via respectively a second port 164, 166 which leads into a corresponding annular chamber 110A, 110B in the master cylinder 110, to the pressureless hydraulic-fluid reservoir (reference symbol 120 in FIG. 1) not represented in FIG. 3.

Between the respectively first port 160, 162 and the respectively second port 164, 166 of the master cylinder 110, a valve 170, 172 has respectively been provided which in the embodiment has been realised as a 2/2-way valve. By means of the valves 170, 172, the first and second ports 160, 162, 164, 166 can be selectively connected to one another. This corresponds to a ‘hydraulic short circuit’ between the master cylinder 110, on the one side, and, on the other side, the pressureless hydraulic-fluid reservoir (which is then connected to the hydraulic chambers 116, 118 via the annular chambers 110A, 110B). In this state the pistons 112, 114 in the master cylinder 110 can be relocated substantially without resistance by the electromechanical actuator 124 or by the mechanical actuator 126 (free-travel enabling′). In this way, the two valves 170, 172 enable, for example, a regenerative braking mode (generator operation). Here the hydraulic fluid displaced out of the hydraulic chambers 116, 118 in the course of a conveying movement in the master cylinder 110 is then routed not to the wheel brakes but to the pressureless hydraulic-fluid reservoir, without a build-up of hydraulic pressure occurring at the wheel brakes (which, as a rule, is undesirable in the regenerative braking mode). A braking action is then achieved in the regenerative braking mode by virtue of the generator (cf. reference symbol 102 in FIGS. 1 and 2).

It should be pointed out that the regenerative braking mode may have been implemented in axle-specific manner. Therefore in the case of an axle-related brake-circuit partitioning in the regenerative braking mode one of the two valves 170, 172 may be closed and the other open.

The two valves 170, 172 furthermore enable the lowering of hydraulic pressure at the wheel brakes. Such a lowering of pressure may be desirable in the event of failure (e.g. a jamming) of the electromechanical actuator 124 or, in the vehicle-dynamics control mode, in order to avoid a return stroke of the electromechanical actuator 124 (e.g. in order to avoid a reaction on the brake pedal). The two valves 170, 172 are also moved into their open position for the purpose of lowering the pressure, as a result of which hydraulic fluid is able to flow back into the hydraulic-fluid reservoir from the wheel brakes via the annular chambers 110A, 110B in the master cylinder 110.

Finally, the valves 170, 172 also enable a refilling of the hydraulic chambers 116, 118. Such a refilling may become necessary during an ongoing braking process (e.g. by reason of so-called brake fading). For the purpose of refilling, the wheel brakes are fluidically separated from the hydraulic chambers 116, 118 via assigned valves of the HCU (not represented in FIG. 3). The hydraulic pressure prevailing at the wheel brakes is accordingly ‘locked in’. Thereupon the valves 170, 172 are opened. In the course of a subsequent return stroke of the pistons 110, 112 provided in the master cylinder 110 (to the right in FIG. 3), hydraulic fluid is then sucked out of the pressureless reservoir into the chambers 116, 118. Finally, the valves 170, 172 can be closed again and the hydraulic connections to the wheel brakes can be opened again. In the course of a following delivery stroke of the pistons 112, 114 (to the left in FIG. 3), the formerly ‘locked-in’ hydraulic pressure can then be increased further.

As shown in FIG. 3, in the present embodiment both a simulation device 108 and a decoupling device 142 are based on a hydraulic principle. Both devices 108, 142 comprise, respectively, a cylinder 108A, 142A for accommodating hydraulic fluid and also a piston 108B, 142B received in the respective cylinder 108A, 142A. The piston 142B of the decoupling device 142 has been mechanically coupled with a brake pedal which is not represented in FIG. 3 (cf. reference symbol 130 in FIGS. 1 and 2). Furthermore, piston 142B possesses an extension 142C extending through cylinder 142A in the axial direction. The piston extension 142C runs coaxially with respect to a force-transmitting element 128 for the primary piston 112 and has been disposed upstream of said primary piston in the direction of actuation of the brake pedal.

Each of the two pistons 108B, 142B is biased into its initial position by an elastic element 108C, 142D (here, a coil spring in each instance). In this connection the characteristic curve of the elastic element 108C of the simulation device 108 defines the desired pedal-reaction response.

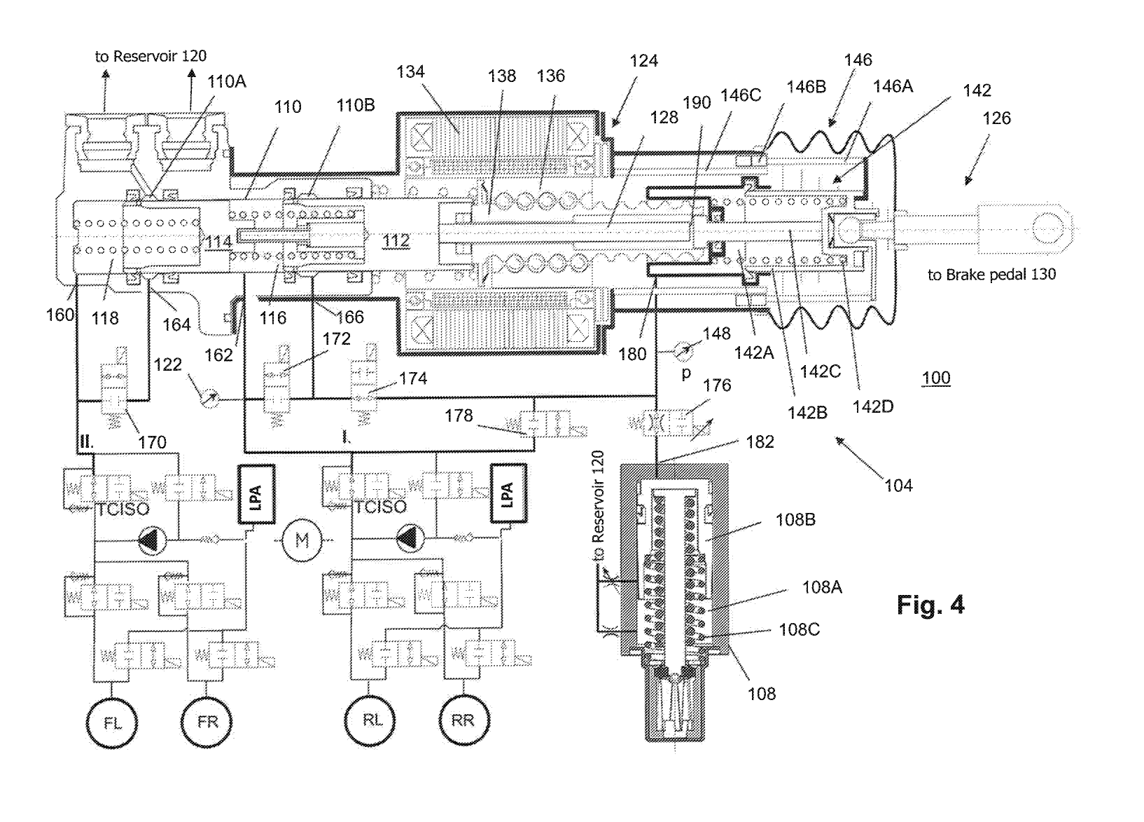

As further shown in FIG. 3, the vehicle brake system 100 in the present embodiment includes three further valves 174, 176, 178 which here have been realised as 2/2-way valves. It will be understood that in other versions in which the corresponding functionalities are not required any or all of these three valves 174, 176, 178 may be omitted. It will furthermore be understood that all these valves may be part of a single HCU block (cf. reference symbol 106 in FIGS. 1 and 2). This HCU block may include further valves (cf. FIG. 4 below).

The first valve 174 has been provided between, on the one side, the decoupling device 142 (via a port 180 provided in cylinder 142A) and also the simulation device 108 (via a port 182 provided in cylinder 108A) and, on the other side, the pressureless hydraulic-fluid reservoir (via port 166 of the master cylinder 110). The second valve 176, which exhibits a throttle characteristic in its passing position, has been inserted upstream of port 182 of cylinder 108A. Lastly, the third valve 178 has been provided between hydraulic chamber 116 (via port 166) and brake circuit I., on the one side, and cylinder 142A of the decoupling device 142 (via port 180), on the other side.

The first valve 174 enables a selective activation and deactivation of the decoupling device 142 (and, indirectly, also of the simulation device 108). If valve 174 is in its open position, cylinder 142A of the decoupling device 142 has been hydraulically connected to the pressureless hydraulic reservoir. In this position the decoupling device 142 has been deactivated in accordance with the emergency-braking mode. Furthermore, the simulation device 108 has also been deactivated.

The opening of valve 174 brings about a situation such that, upon relocation of piston 142B (as a consequence of an actuation of the brake pedal), the hydraulic fluid accommodated in cylinder 142A can be conveyed into the pressureless hydraulic-fluid reservoir largely without resistance. This process is substantially independent of the position of valve 176, since the latter has a significant throttling effect also in its open position. Consequently, in the open position of valve 174 the simulation device 108 has also been indirectly deactivated.

In the event of an actuation of the brake pedal in the open state of valve 174, the piston extension 142C overcomes a gap 190 towards the force-transmitting element 128 and in consequence comes into abutment against the force-transmitting element 128. After overcoming the gap 190, the force-transmitting element 128 is captured by the relocation of the piston extension 142C and thereupon actuates the primary piston 112 (and also—indirectly—the secondary piston 114) in the master brake cylinder 110. This corresponds to the direct coupling of brake pedal and master-cylinder piston, already elucidated in connection with FIG. 1, for the purpose of building up hydraulic pressure in the brake circuits I., II. in the emergency-braking mode.

With valve 174 closed (and valve 178 closed), the decoupling device 142 has, on the other hand, been activated. This corresponds to the service-braking mode. In this case, hydraulic fluid is conveyed out of cylinder 142A into the cylinder 108A of the simulation device 108 in the event of an actuation of the brake pedal. In this way, the simulator piston 108B is relocated against the counterforce provided by the elastic element 108C, so that the habitual pedal-reaction response arises. At the same time, the gap 190 between the piston extension 142C and the force-transmitting element 128 continues to be maintained. As a result, the brake pedal has been mechanically decoupled from the master cylinder.

In the present embodiment, the maintenance of the gap 190 is effected by virtue of the fact that by means of the electromechanical actuator 124 the primary piston 112 is moved to the left in FIG. 3 at least as quickly as piston 142B moves to the left by reason of the actuation of the brake pedal. Since the force-transmitting element 128 has been coupled mechanically or otherwise (e.g. magnetically) with the primary piston 112, the force-transmitting element 128 moves together with the primary piston 112 when the latter is actuated by means of the gearing spindle 138. This entrainment of the force-transmitting element 128 permits the maintenance of the gap 190.

The maintenance of the gap 190 in the service-braking mode requires a precise registration of the distance travelled by piston 142B (and hence of the pedal travel). For this purpose a distance sensor 146 based on a magnetic principle has been provided. The distance sensor 146 includes a tappet 146A rigidly coupled with piston 142B, at the end of which a magnetic element 146B has been fitted. The movement of the magnetic element 146B (i.e. the distance travelled by the tappet 146A or by piston 142B) is registered by means of a Hall-effect sensor 146C. An output signal of the Hall-effect sensor 146C is evaluated by a control unit which is not shown in FIG. 3 (cf. reference symbol 150 in FIGS. 1 and 2). On the basis of this evaluation, the electromechanical actuator 124 can then be driven.

Now with reference to the second valve 176, which has been inserted upstream of the simulation device 108 and in many versions may be omitted. This valve 176 has a predetermined or adjustable throttle function. By means of the adjustable throttle function it is possible, for example, for a hysteresis or other characteristic for the pedal-reaction response to be achieved. Furthermore, by selective closing of valve 176 the motion of piston 142B (with valves 174, 178 closed), and hence of the brake-pedal travel, can be limited.

In its open position the third valve 178 enables the conveying of hydraulic fluid out of cylinder 142A into brake circuit I. or, to be more exact, into hydraulic chamber 116 of the master cylinder 110 and conversely. A conveying of fluid out of cylinder 142A into brake circuit I. enables, for example, a rapid application of the brakes (e.g. prior to the onset of the conveying action of the electromechanical actuator 124), whereby valve 178 is immediately closed again. Furthermore, with valve 178 open it is possible for a hydraulic reaction on the brake pedal (e.g. a pressure modulation in the vehicle-dynamics control mode, generated by means of the electromechanical actuator 124) to be achieved via piston 142B.

In a hydraulic line leading into port 180 of cylinder 142A a pressure sensor 148 has been provided, the output signal of which permits an inference as to the actuating force on the brake pedal. The output signal of this pressure sensor 148 is evaluated by a control unit which is not shown in FIG. 3. On the basis of this evaluation, a drive of one or more of the valves 170, 172, 174, 176, 178 can then be effected for the purpose of realising the functionalities described above. Furthermore, on the basis of this evaluation the electromechanical actuator 124 can be driven.

In the case of the brake system 100 shown in FIG. 3, use may be made of the HCU 106 represented in FIG. 1. An exemplary realisation of this HCU 106 for the brake system 100 according to FIG. 3 has been shown in FIG. 4. Here a total of 12 (additional) valves for realising the vehicle-dynamics control functions have been provided, as well as an additional hydraulic pump. In an alternative version, for the brake system 100 shown in FIG. 3 the multiplex arrangement according to FIG. 2 (with a total of four valves in addition to the valves illustrated in FIG. 3) may also find application.

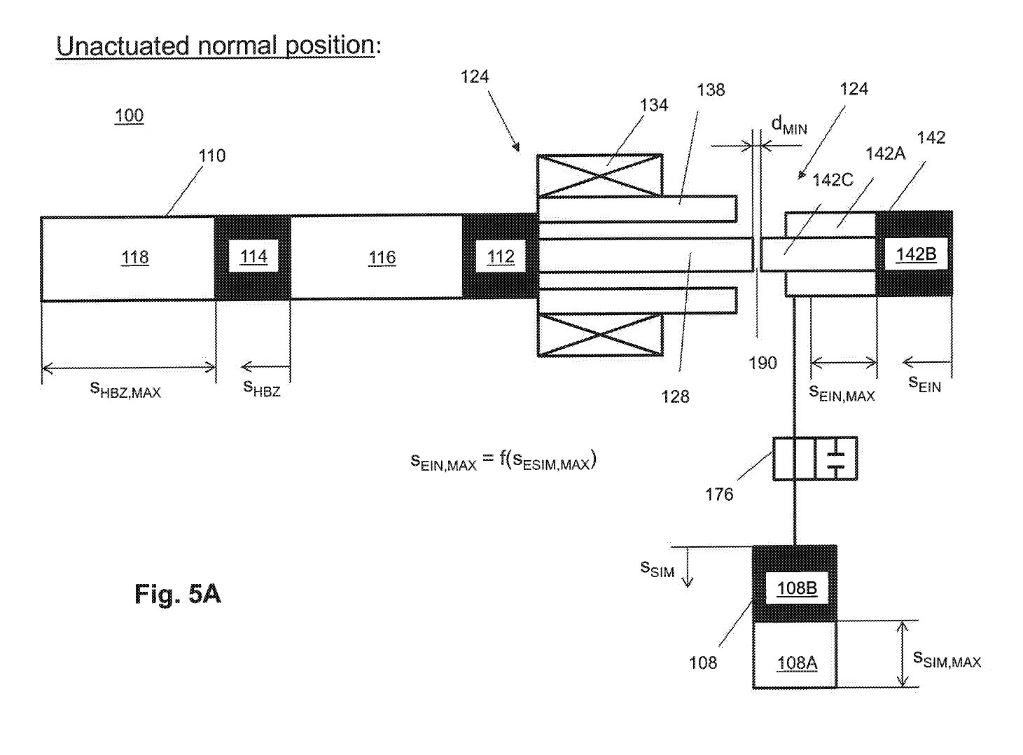

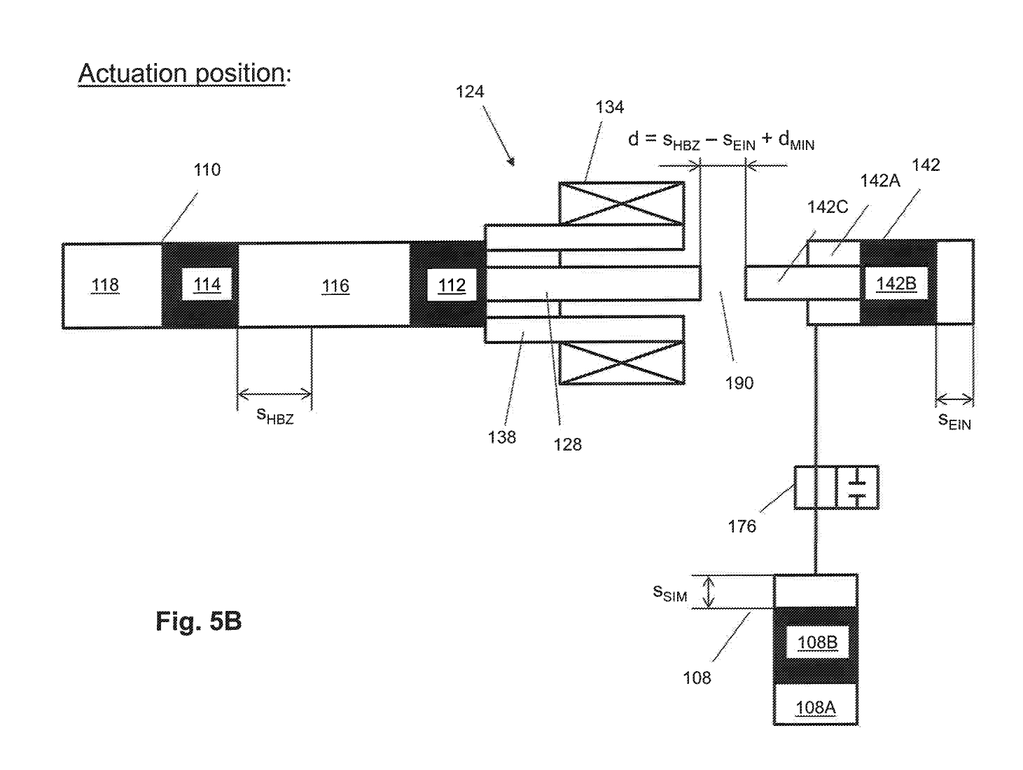

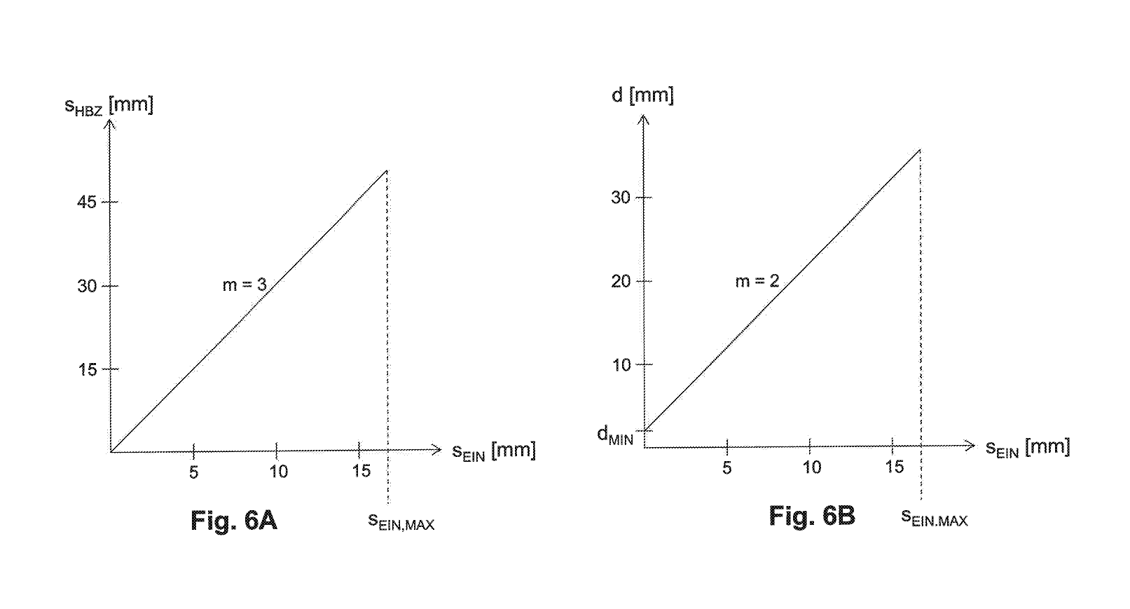

Also in the embodiments according to FIGS. 3 and 4 there is a pedal-travel dependence of the gap 190 between the force-transmitting element 128, on the one side, and the piston extension 142C, on the other side. In the following, with reference to the schematic FIGS. 5A and 5B the processes in the course of actuation of the brake system 100 in FIG. 3 or 4 will be elucidated in more detail with regard to the travel dependence of a length d of the gap 190 (‘gap length d’). It will be understood that the corresponding technical particulars can be implemented also in the case of the brake system 100 according to FIG. 1 or FIG. 2.

In FIGS. 5A and 5B the components of the brake system 100 according to FIG. 3 or 4 that are crucial for an elucidation of the travel dependence of the gap length d have been represented. In this connection FIG. 5A illustrates the unactuated normal position of the brake system 100 in the BBW mode (that is to say, with brake pedal unactuated), whereas FIG. 5B shows the actuation position in the BBW mode.

As illustrated in FIG. 5A, the gap 190 has been formed between mutually facing end faces of the force-transmitting element 128, on the one side, and of the piston extension 142C, on the other side. In the unactuated normal state according to FIG. 5A the gap length d exhibits a predetermined minimum value d_{MIN} of about 1 mm.

In the event of an actuation of the brake pedal, the piston 142B in cylinder 142A is relocated to the left in FIG. 5A and travels a distance s_{EIN}. In the BBW mode, valve 176 between cylinder 142A and the cylinder 108A of the simulation device 108 is normally open. The hydraulic fluid displaced out of chamber 142A in the event of a relocation of piston 142B can consequently be displaced into cylinder 108A and in the process relocates piston 108B in FIG. 5A downwards contrary to a spring force (cf. element 108C in FIGS. 3 and 4). This spring force brings about the pedal-reaction response familiar to the driver.

The distance s_{EIN} that piston 142B in cylinder 142A can travel in the event of an actuation of the brake pedal has been limited to a maximum value s_{EIN,MAX} of, typically, 10 mm to 20 mm (e.g. about 16 mm). This limitation also brings about a limitation of the brake-pedal travel.

In the embodiment according to FIG. 5A the limitation to the maximum value s_{EIN,MAX} results by reason of a stop in cylinder 108A for piston 108B, which limits the travel s_{SIM} of piston 108A to a maximum value s_{SIM,MAX}. Between the maximum values s_{EIN,MAX} and s_{SIM,MAX} there exists a functional relationship which has been predetermined by the volume of hydraulic fluid relocated between the two cylinders 142A, 108A and the hydraulically active working surfaces of the two pistons 142B, 108B.

As already elucidated above, there is the possibility to limit the travel s_{EIN} to a lower maximum value than has been established by s_{SIM,MAX}. This limitation comes about by closing valve 176 before piston 108B reaches its stop in cylinder 108A (it will be assumed here that the hydraulic fluid displaced out of cylinder 142A cannot escape otherwise—that is to say, for example, valves 174, 178 in FIGS. 3 and 4 are closed).

The limitation of the travel s_{EIN} by closing of valve 176 consequently limits the pedal travel. Such a pedal-travel limitation is undertaken in the present embodiment in the event of deployment of an ABS control. By virtue of shortening of the pedal travel when valve 176 is closed, the attention of the driver is drawn by haptic means to a low coefficient of static friction of the roadway surface and to the deployment of the ABS control. In this case the pedal-travel limitation may start more quickly (i.e. the maximum pedal travel may be shorter), the lower the coefficient of static friction. This pedal-reaction response is known to a driver of conventional brake systems which are not based on the BBW principle.

In the event of an actuation of the brake pedal in the BBW mode the electromechanical actuator 124 is driven in order to act, by means of the spindle 138, on the primary piston 112 in the master cylinder 110, and hence also on the secondary piston 114. The piston arrangement 112, 114 is thereupon relocated by a distance s_{HBZ} to the left in FIG. 5A (or, upon release of the brake pedal, to the right). The distance s_{HBZ} has likewise been limited to a maximum value s_{HBZ,MAX} of approximately 35 mm to 50 mm (e.g. about 42 mm). This limitation results by reason of a stop in the master cylinder 110 for at least one of the two pistons 112, 114.

As already specified above, the force-transmitting element 128 has been fixedly or releasably (e.g. by magnetic forces) and mechanically coupled with the primary piston 112. A relocation of the primary piston 112 (and of the secondary piston 114) in the master cylinder 110 therefore brings about the same relocation, in terms of direction and distance, of the force-transmitting element 128.

The drive of the electromechanical actuator 124 is now effected in such a manner that a certain transmission ratio has been defined between s_{EIN} and s_{HBZ}. The transmission ratio has been chosen in the embodiment to be >1 and amounts, for example, to 1:3 (cf. FIG. 6A). By reason of the rigid coupling of the force-transmitting element 128 with the primary piston 112, and also of the piston extension 142C with piston 142B, the same transmission ratio arises between a distance travelled by the end face of the piston extension 142C facing towards the force-transmitting element 128 and a distance travelled by an end face of the force-transmitting element 128 assigned to the piston extension 142C.

The transmission ratio has consequently been chosen in such a manner that the gap length d increases continuously with depression of the brake pedal. Hence it is ensured that the force-transmitting element 128 moves more quickly to the left in FIG. 5B than the piston extension 142C following it. Accordingly, it is possible to speak here of a transmission between the travel s_{EIN} of piston 142B and the gap length d, whereby the transmission ratio, as shown in FIG. 6B, amounts to about 2 (and generally may lie between 1:1.5 and 1:4).

The increasing gap length d with depression of the brake pedal is advantageous from the point of view of safety, since with increasing brake-pedal travel a ‘stronger’ mechanical decoupling of the brake pedal from the piston arrangement 112, 114 in the master cylinder 110 is obtained.

The increasing gap length d is also advantageous from another point of view.

As already elucidated above, in the case of the brake system 100 according to FIG. 3 or 4 it may in certain situations become necessary, within the scope of a service braking (e.g. after deployment of a vehicle-dynamics control), to suck further hydraulic fluid out of the reservoir into the master cylinder 110. For this purpose, as already elucidated, the fluid lines to the wheel brakes are closed, and the refilling valves 170, 172 are opened. Furthermore, by means of the electromechanical actuator 124 a return stroke of the pistons 112, 114 is initiated, in order to suck hydraulic fluid out of the reservoir into the hydraulic chambers 116, 118. As a consequence of the return stroke, the piston arrangement 112, 114, and hence also the force-transmitting element 128, moves to the right in FIG. 3.

By reason of the comparatively large gap length d=s_{HBZ}−s_{EIN}+s_{MIN}, a significant return stroke (and therefore a significant volumetric intake of hydraulic fluid in the master cylinder 110) can occur, without the force-transmitting element 128 impinging on the piston extension 142C by overcoming the gap 190. An undesirable haptic feedback on the brake pedal can be avoided in this way. At the same time, it is ensured that in the unactuated normal position only a small gap length d_{MIN} is present. Accordingly, should switching to the PT mode have to be effected, the gap 190 of length d_{MIN} can be overcome quickly, resulting in a largely instantaneous coupling of the piston extension 142C with the force-transmitting element 128.

In the embodiments according to FIGS. 3, 4, 5A and 5B the gap 190 has been provided between the force-transmitting element 128 and the piston extension 142C. It should be pointed out that, in other versions, the gap could also be provided at another place in the force-transmitting path between the brake pedal 130 and the master-cylinder/piston arrangement 112, 114. For example, it is conceivable to form the piston extension 142C and the force-transmitting element 128 as a single, gap-free component. In this case, a gap could then have been provided between the end face of the primary piston 112 facing towards the brake pedal and the end face of the integrated element 128, 142C facing towards the primary piston 112.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Electrohydraulic motor-vehicle brake system (100) comprising
a master cylinder (110);
an electromechanical actuator (124) for actuating a first piston (112; 114) received in the master cylinder (110) in a brake-by-wire (BBW) mode of the brake system (100);
a mechanical actuator (126), capable of being actuated by means of a brake pedal (130), for actuating the first piston (112; 114) in a push-through (PT) mode of the brake system (100),
wherein in the BBW mode a gap (190) with a gap length (d) is present in a force-transmitting path between the brake pedal (130) and the first piston (112; 114) in order to decouple the brake pedal (130) from the first piston (112; 114) and wherein the brake system (100) is configured in such a manner that in the BBW mode the gap length (d) exhibits a dependence on a pedal travel of the brake pedal (130).

2. Brake system according to claim 1, wherein
the gap length (d) increases with a depression of the brake pedal (130).

3. Brake according to claim 1 or 2, wherein
the dependence of the gap length (d) on the pedal travel is defined by a transmission ratio between a distance travelled by a pedal-side boundary of the gap (190) and a distance travelled by a piston-side boundary of the gap (190).

4. Brake system according to claim 3, wherein
the transmission ratio lies within the range between about 1:1.25 and 1:6.

5. Brake system according to one of the preceding claims, wherein
the gap (190) is bounded between a first end face of the first piston (112; 114) or of a first actuating element (128) capable of being moved with the first piston (112; 114), on the one side, and a second end face of a second actuating element (142C) coupled with the brake pedal (130), on the other side.

6. Brake system according to claim 5, wherein
in the PT mode the first end face and the second end face are capable of being brought into abutment, overcoming the gap (190), in order to actuate the first piston by means of the brake pedal (130).

7. Brake system according to one of the preceding claims, wherein
the dependence of the gap length (d) on the pedal travel is realised by a pedal-travel-dependent and/or a pedal-force-dependent drive capability of the electromechanical actuator (124).

8. Brake system according to one of the preceding claims, wherein
the electromechanical actuator (124) is capable of being driven in such a manner that in the event of a depression of the brake pedal (130) the first piston (112; 114) is traversed more quickly by means of the electromechanical actuator (124) than a brake-pedal-side boundary of the gap (190) lagging behind the first piston (112; 114).

9. Brake system according to one of the preceding claims, wherein
the electromechanical actuator (124) is capable of being driven in order to bring about, when the brake pedal (130) is at least partially depressed, a return stroke of the first cylinder (112; 114) in the direction towards the brake pedal (130).

10. Brake system according to claim 9, wherein
the return stroke serves for a suction of hydraulic fluid out of a reservoir (120) into the master cylinder (110).

11. Brake system according to one of the preceding claims, wherein
a hydraulic cylinder (142A) with a second piston (142B) received therein is provided, wherein the brake pedal (130) is coupled with the second piston (142B) in order in the event of a depression of the brake pedal (130) to displace hydraulic fluid out of the hydraulic cylinder (142A).

12. Brake system according to claim 11, wherein
the second piston (142B) is rigidly coupled with an actuating element (142C) forming a pedal-side boundary of the gap (190).

13. Brake system according to claim 11 or 12, wherein
a hydraulic simulation device (108) for a pedal-reaction response is provided, which has been designed to accommodate hydraulic fluid displaced out of the hydraulic cylinder (142A).

14. Brake system according to one of claims 11 to 13, wherein
a stop valve (176) is provided between the hydraulic cylinder (142A) and the simulation device (108).

15. Brake system according to claim 14, wherein
for the purpose of pedal-travel limitation by means of the stop valve (176), the hydraulic cylinder (142A) is separable from the simulation device (108).

16. Method for operating an electrohydraulic motor-vehicle brake system (100) with a master cylinder (110), with an electromechanical actuator (124) for actuating a first piston (112; 114) received in the master cylinder (110) in a brake-by-wire (BBW) mode of the brake system (100) and with a mechanical actuator (126), capable of being actuated by means of a brake pedal (130), for actuating the first piston (112; 114) in a push-through (PT) mode of the brake system (100), wherein in the BBW mode a gap (190) with a gap length (d) is present in a force-transmitting path between the brake pedal (130) and the first piston (112; 114) in order to decouple the brake pedal (130) from the first piston (112; 114), comprising the step of:
setting, in the BBW mode, the gap length (d) as a function of a pedal travel of the brake pedal (130).

17. Computer-program product with program-code means for implementing the method according to claim 16 when the computer-program product is running on at least one processor.

18. Motor-vehicle control unit or motor-vehicle control-unit system including the computer-program product according to claim 17.
